(19) United States
(12) Patent Application Publication
(10) Pub. No.: US 2012/0121976 A1
(43) Pub. Date: May 17, 2012

(54) POROUS NETWORK NEGATIVE ELECTRODES FOR NON-AQUEOUS ELECTROLYTE SECONDARY BATTERY

(75) Inventor: Hizuru Koshina, Mountain View, CA (US)

(73) Assignee: PANASONIC CORPORATION, Osaka (JP)

(21) Appl. No.: 12/946,980

(22) Filed: Nov. 16, 2010

(51) Int. Cl. H01M 4/133; H01M 4/64; H01M 10/26; H01M 4/131; H01M 4/134; H01M 4/66; H01M 4/13

(52) U.S. Cl. 429/207; 429/233; 429/218.1; 429/231.8; 429/212; 977/734; 977/773

(57) ABSTRACT

An electrode of a non-aqueous electrolyte secondary battery comprises a current collector and a mixture comprising an electrode active material and a binder on the current collector. The electrode active material comprises a porous composite material, in which the porous composite material comprises a lithium absorbing material and a conductive material. The lithium absorbing material may be silicon, tin, silicon oxide, tin oxide, and mixtures thereof. The lithium absorbing material may specifically be the nanoparticles of silicon, tin, silicon oxide, tin oxide, and mixtures thereof. The conductive material may be, for example, acetylene black, ketchen black, carbon black, vapor grown carbon fibers (VGCF), and mixtures thereof. The conductive material may be disposed within the electrode active material rather than outside of the active material. The electrode active material is used in the electrodes of non-aqueous secondary batteries, preferably as the negative electrode active material.

### FIELD OF THE INVENTION

This invention relates to non-aqueous secondary batteries. Specifically, this invention relates to negative electrode materials for non-aqueous secondary batteries.

### BACKGROUND OF THE INVENTION

Cordless portable electronic devices, such as personal computers, cell phones, and smart phones, as well as audio-visual electronic devices, such as video camcorders and MP3 players, are rapidly becoming smaller and lighter in weight. Because these devices are designed to be light weight and compact, a demand for compact and light weight secondary batteries that have a higher energy density than that obtainable by conventional lead-acid batteries, nickel-cadmium storage batteries, or nickel-metal hydride storage batteries has developed.

Non-aqueous electrolyte secondary batteries have been extensively developed to meet this demand. Although lithium is the best candidate for the anode material (3860 mAh/g), repeated dissolution and deposition of lithium during discharging and charging cycles, causes the formation of dendritic lithium on the surface of lithium. Dendrites decrease charge-discharge efficiency and can pierce the separator and contact the positive electrode, causing a short circuit and unacceptably shortening the life of the battery. In addition, the circuit density is high at the end of a dendrite, which can cause decomposition of the non-aqueous solvent.

Carbon materials, such as graphite, capable of absorbing and desorbing lithium have been used as the negative electrode active material in lithium non-aqueous electrolyte secondary batteries. When a graphite material is used as the negative electrode active material, lithium is released at an average potential of about 0.2 V. Because this potential is low compared to non-graphite carbon, graphite carbon has been used in applications where high cell voltage and voltage flatness are desired. However, the search for alternate anode materials is continuing because the theoretical discharge capacity of graphite is about 372 mAh/g. Thus, these batteries cannot meet the demand for high energy density required for many light weight mobile electrical and electronic devices.

Materials that are capable of absorbing and desorbing lithium and showing high capacity include simple substances such as silicon and tin. Elemental silicon and elemental tin are each high energy density materials that react with lithium at low voltage with respect to Li/Li⁺. However, silicon and tin each have an enormous volume expansion problem. When broken to be smaller particles, the electric contact of silicon and tin with conductors such as carbon powders decreases. Additionally, electric resistance increases when silicon and tin absorb lithium. When the battery case has low strength, such as a prismatic case made of aluminum or iron, or an exterior component which is made of an aluminum foil having a resin film on each face thereof (i.e., an aluminum laminate sheet), the battery thickness increases due to volume expansion of the negative electrode, such that an instrument storing the battery could be damaged. In a cylindrical battery using a battery case with high strength, because the separator between a positive electrode and a negative electrode is strongly compressed due to volume expansion of the negative electrode and can cause rupture of the separator film, an electrolyte-depleting region is created between the positive electrode and the negative electrode, thereby making the battery life even shorter.

However, it is desirable to have anode material having a larger free volume for Li⁺-ion motion within the host structure without much change in the host structure. An inexpensive, non-polluting compound would make the battery environmentally benign. Thus, there is a continuing need for alkali-ion batteries that do not have volume expansion problems. Additionally, it is desirable to utilize electronic conductive materials to fabricate the host structure to improve the performance characteristics of the battery.

### SUMMARY OF THE INVENTION

The present invention relates to an electrode active material for a non-aqueous secondary battery, an electrode comprising the active material, and a non-aqueous secondary battery that comprises the electrode active material. The electrode active material comprises a porous composite material of a conductive material, such as carbon particles, and a lithium absorbing nano-material.

In one embodiment, the invention is an electrode of a non-aqueous electrolyte secondary battery, the electrode comprising: a current collector and a mixture comprising an electrode active material and a binder on the current collector; in which the electrode active material comprises a porous composite material of a conductive material and a lithium absorbing nano-material.

In another embodiment, the present invention is a non-aqueous electrolyte secondary battery comprising: a positive electrode, a negative electrode, and a non-aqueous electrolyte and separator between the positive electrode and the negative electrode; in which the non-aqueous electrolyte comprises a non-aqueous solvent and lithium salt; the positive electrode comprises a positive electrode current collector, and, on the positive electrode current collector, a mixture comprising a positive electrode active material and a first binder; the negative electrode comprises a negative electrode current collector, and, on the negative electrode current collector, a mixture comprising a negative electrode active material and a second binder; and either the negative electrode active material or the positive electrode active material comprises a porous composite material of a conductive material and a lithium absorbing nano-material. The separator is made of an electrical insulator and has a small pore to hold the electrolyte.

In yet another embodiment, the present invention is an electrode of a non-aqueous electrolyte secondary battery, the electrode comprising: a current collector and a mixture comprising an electrode active material and a binder on the current collector; in which the electrode active material comprises a porous composite material of a conductive material and a lithium absorbing nano-material, wherein the conductive material is disposed within the electrode active material rather than outside of the active material.

### BRIEF DESCRIPTION OF THE DRAWING

FIG. 1 is a schematic drawing of a non-aqueous electrolyte secondary battery.

FIG. 2 is a cross-sectional drawing of a coin type cell battery.

FIG. 3 shows the voltage vs. capacity charge/discharge curves for the materials described in Examples 1-5.

FIG. 4 shows charge-discharge cycle performance for the materials described in Examples 1-5.

### DETAILED DESCRIPTION OF THE INVENTION

Unless the context indicates otherwise, in the specification and claims, the terms binder, conductive material, negative electrode active material, positive electrode active material, lithium salt, non-aqueous solvent, additive, and similar terms also include mixtures of such materials. Unless otherwise specified, all percentages are percentages by weight and all temperatures are in degrees Centigrade (degrees Celsius). The term “mesoporous” refers to a porous material with a predominant pore distribution in the range from 2 nm to 50 nm. Materials with a predominant pore distribution less than 2 nm may be considered microporous. Materials with a predominant pore distribution exceeding about 50 nm may be considered macroporous. The term “porous” refers to any porous materials with a predominant pore distribution in the mesoporous, macroporous or microporous ranges. It is noted that the terms “mesoporous,” “microporous,” and “macroporous” are not rigidly defined in the art and may change according to the context. The porous materials of the present invention may have a predominant pore distribution up to about 100 nm. The present invention also contemplates a distribution of pores in the different distributions. This is particularly evident with pores in the mesoporous and macroporous ranges.

The invention relates to the use of porous network materials as electrode materials in non-aqueous secondary batteries. In one aspect, the invention is an electrode material for a rechargeable secondary battery comprising a positive electrode, a negative electrode, an electrolyte, and optionally an electrode separator in which the battery comprises a porous electrode material. The porous electrode material may be either a positive electrode material or a negative electrode material. However, the material is preferably useful in the negative electrode.

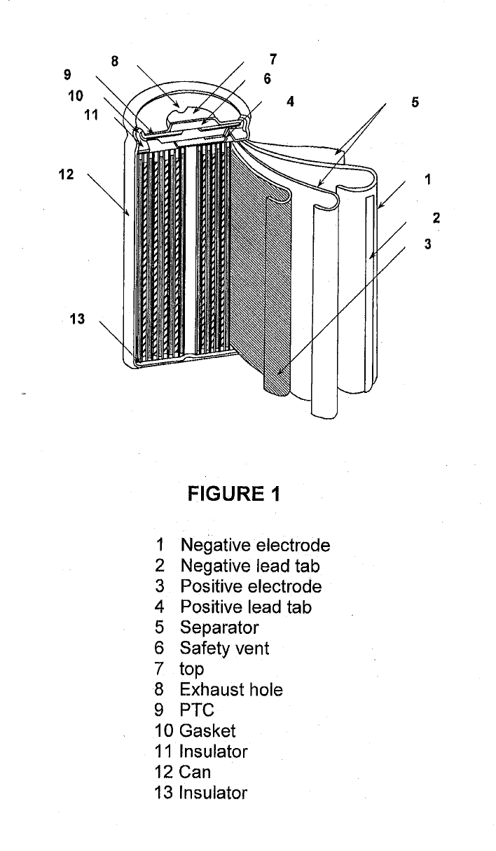

Referring to FIG. 1, the non-aqueous secondary battery comprises negative electrode 1, negative lead tab 2, positive electrode 3, positive lead tab 4, separator 5, safety vent 6, top 7, exhaust hole 8, PTC (positive temperature coefficient) device 9, gasket 10, insulator 11, battery case or can 12, and insulator 13. Although the non-aqueous secondary battery is illustrated as cylindrical structure, any other shape, such as prismatic, aluminum pouch, or coin type may be used.

### Negative Electrode

Negative electrode 1 comprises a current collector and, on the current collector, a mixture comprising a negative electrode active material and a binder.

The current collector can be any conductive material that does not chemically change within the range of charge and discharge electric potentials used. Typically, the current collector is a metal such as copper, nickel, iron, titanium, or cobalt; an alloy comprising at least one of these metals such as stainless steel; or copper or stainless steel surface-coated with carbon, nickel or titanium. The current collector may be, for example, a film, a sheet, a mesh sheet, a punched sheet, a lath form, a porous form, a foamed form, a fibrous form, or, preferably, a foil. A foil of copper or a copper alloy, or a foil having a copper layer deposited on its surface by, for example electrolytic deposition, is preferred. The current collector is typically about 1-500 μm thick. It may also be roughened to a surface roughness of Ra is 0.2 μm or more to improved adhesion of the mixture of the negative electrode active material and the binder to the current collector.

The negative electrode active material comprises a porous composite material of a conductive material and a lithium absorbing nano-material. The nano-material may include a nano-dimensional material, a nanoparticle, “partially nanoparticle,” a nano-fiber, a nano-ribbon, a nano-rod, a nano-whisker, or a nanotube. Nano-dimensional materials encompass materials which are measurable on a nano-scale in length in at least one dimension, e.g., nano-sized materials. To further illustrate nano-dimensional materials, for the case of a reduced metal salt, such as a tin salt reduced under H₂—Ar atmosphere, the material is measurable on a nano-scale in length in at least one dimension. Nanoparticles may be partially amorphous. “Partially nanoparticle” may include agglomerated nano-particles. The lithium absorbing nano-material may include a silicon, tin, silicon oxide (SiOₓ, 0<x<2), or tin oxide (SnOₓ, 0<x≦2), or mixtures thereof.

The porous structure can be made by any method known in the art such as, for example, by using a soft template fabricated by non-ionic surfactants. For example, an ethylene oxide/propylene oxide block copolymer surfactant such as that sold by BASF (Florham Park, N.J. USA) under the trade name “PLURONIC® P-123” may be used as the non-ionic surfactant for fabrication of the porous structure. Other solutions may be used in place of, or in addition to the surfactant for this purpose, such as for example, a 50% sucrose water solution. The use of composite materials containing a conductive material and a lithium-absorbing nano-material such as silicon, tin, or their respective oxides, has been found to improve the performance characteristics of the negative electrodes according to the present invention. The negative electrode active material may further comprise nanotubes, more specifically carbon nanotubes (CNT), and more particularly multi-walled carbon nanotubes. Nanotubes are well known in the art and are defined by their ordinary and customary meaning.

At least part of the surface of the negative electrode active material is covered with a conductive material. Any conductive material known in the art can be used. Typical conductive materials include carbon, such as graphite, for example, natural graphite (scale-like graphite), synthetic graphite, and expanding graphite; carbon black, such as acetylene black, ketchen black (highly structured furnace black), channel black, furnace black, lamp black, and thermal black; conductive fibers such as carbon fibers and metallic fibers; metal powders such as copper and nickel; organic conductive materials such as polyphenylene derivatives; and mixtures thereof. Acetylene black, ketchen black, carbon black, and carbon fibers, such as vapor grown carbon fibers (VGCF), are preferred.

The binder for the negative electrode can be either a thermoplastic resin or a thermosetting resin. Useful binders include: polyethylene, polypropylene, polytetrafluoroethylene (PTFE), polyvinylidene fluoride (PVDF), styrene/butadiene rubber, tetrafluoroethylene/hexafluoropropylene copolymers (FEP), tetrafluoroethylene/perfluoro-alkyl-vinyl ether copolymers (PFA), vinylidene fluoride/-hexafluoropropylene copolymers, vinylidene fluoride/chlorotrifluoroethylene copolymers, ethylene/tetrafluoroethylene copolymers (ETFE), polychlorotrifluoroethylene (PCTFE), vinylidene fluoride/pentafluoropropylene copolymers, propylene/tetrafluoroethylene copolymers, ethylene/-chlorotrifluoroethylene copolymers (ECTFE), vinylidene fluoride/hexafluoropropylene/-tetrafluoroethylene copolymers, vinylidene fluoride/perfluoromethyl vinyl ether/-tetrafluoroethylene copolymers, and mixtures thereof. Polytetrafluoroethylene and polyvinylidene fluoride are preferred binders.

Negative electrode 1 may be prepared by mixing the negative electrode active material, which includes the conductive material and the lithium-absorbing nano-material, and the binder with a solvent, such as N-methylpyrrolidone. The resulting paste or slurry is coated onto the current collector by any conventional coating method, such as bar coating, gravure coating, die coating, roller coating, or doctor knife coating. Typically, the current collector is dried to remove the solvent and then rolled under pressure after coating. The mixture of negative electrode active material and the binder typically comprises the negative electrode active material, which contains at least enough conductive material for good conductivity, and at least enough binder to hold the mixture together. The negative electrode active material may typically comprise from about 1 wt % to about 99 wt % of the mixture of negative electrode active material and binder.

The porous network may be the positive electrode material. When the porous network is the positive electrode material, the negative electrode material may be, for example, a carbonaceous material, such as coke, artificial graphite, or natural graphite. The negative electrode is prepared by mixing the negative electrode active material and a binder with a solvent and coating on a current collector as described above.

### Preparation of Porous Networks

Porous networks of oxide materials can be synthesized by using a suitable template (surfactants, block co-polymers, liquid crystals, ionic liquids, ice crystals at the critical transition temperature, proteins, etc) and electronic conductive materials, such as carbon particles, in general. Composite structural materials having a mesoporous network were recently investigated by Sugnaux, U.S. Pat. Publication No. 2004/0131934 A1, the disclosure of which is incorporated herein by reference, and Hambitzer, U.S. Pat. Publication No. 2005/0106467 A1, the disclosure of which is incorporated herein by reference. Synthesis of mesoporous networks is also disclosed in Liu, U.S. Pat. No. 5,645,891, the disclosure of which is incorporated herein by reference; Stucky, U.S. Pat. No. 6,592,764, the disclosure of which is incorporated herein by reference; and Yu, U.S. Pat. No. 6,803,077, the disclosure of which is incorporated herein by reference.

For example, in the porous networks of the invention, a surfactant, such as a block co-polymer, is added to an organic solvent, such as methanol or ethanol. At least one lithium absorbing nano-material is added. More specifically, for example, nanoparticles of silicon, nanoparticles of tin, or in-situ generated from metal salts such as tin from its salts, e.g., SnCl₄.5H₂O, or silicon oxide (SiOₓ, 0<x<2), or tin oxide (SnOₓ, 0<x≦2), or mixtures thereof, may be added. Nanotubes such as carbon nanotubes may also be added to the mixture. The mixture is made acidic, typically pH<1, by the addition of a strong acid such as hydrochloric acid. When nano-materials are added, they are thoroughly dispersed by, for example, ultrasound dispersion. The mixture is dried, for example at 80° C. for 4 hours.

Then the dried material is heated, for example at 400° C. to 1000° C., in a reducing atmosphere, for example 1% hydrogen in argon. This produces a nano-material in the porous network of an active material and an electronic conductive material, such as carbon. As shown in the Examples, the nanoparticles of silicon are capable of absorbing and desorbing lithium to produce nano-materials that comprise absorbed lithium. When these nano-materials absorb lithium, the thickness expansion (or volume expansion) of the electrode upon charging expands less than 20% for the first few charging cycles.

When the synthesis is carried out in a reducing atmosphere, decomposition of the surfactant may also leave amorphous carbon in the porous network as well as some partially decomposed surfactant. Therefore, the nanoparticle-containing porous network also comprises some amorphous carbon or partially graphitized carbon and some partially decomposed surfactant.

### Positive Electrode

Positive electrode 3 typically comprises a current collector and, on the current collector, a mixture comprising a positive electrode active material and a binder. Typical current collectors, conductive materials, and binders for the positive electrode include the current collectors, conductive materials, and binders described above for the negative electrode.

As noted above, the positive electrode active material may be the porous network. However, when the negative electrode active material is the porous network, the positive electrode active material may include any compound containing lithium that is capable of occluding and of releasing lithium ions (Li⁺). A transition metal oxide, with an average discharge potential in the range of 3.5 to 4.0 V with respect to lithium, has typically been used. As the transition metal oxide, lithium cobalt oxide (LiCoO₂), lithium nickel oxide (LiNiO₂), lithium manganese oxide (LiMn₂O₄), a solid solution material (LiCoₓNi_{y}Mn_{z}O₂, Li(COₐNi_{b}Mn_{c})₂O₄) with a plurality of transition metals introduced thereto, and the like, may be used. The average diameter of particles of the positive electrode active material is preferably about 1-30 μm.

Positive electrode 3 can be prepared by mixing the positive electrode active material and the binder with a solvent and coating the resulting slurry on the current collector as was described for preparation of the negative electrode.

In the non-aqueous electrolyte secondary battery, it is preferred that at least the surface of the negative electrode comprising the negative electrode active material is oriented to face the surface of the positive electrode comprising the positive electrode active material. Further, the electrodes are separated by a porous separator as an electrical insulator and allow lithium ions and solvent molecules may pass though. Generally, in a solid state battery, the separator is insulating but is a lithium-ion conducting ceramic. A polymeric gel separator can also be used.

### Non-Aqueous Electrolyte and Separator

The non-aqueous electrolyte is typically capable of withstanding a positive electrode that discharges at a high potential of 3.5 to 4.0 V and also capable of withstanding a negative electrode that charges and discharges at a potential close to lithium. The non-aqueous electrolyte comprises a non-aqueous solvent, or mixture of non-aqueous solvent, with a lithium salt, or a mixture of lithium salts, dissolved therein.

Typical non-aqueous solvents include, for example, cyclic carbonates as ethylene carbonate (EC), propylene carbonate (PC), dipropylene carbonate (DPC), butylene carbonate (BC), vinylene carbonate (VC), phenyl ethylene carbonate (ph-EC), and vinyl ethylene carbonate (VEC); open chain carbonates as dimethyl carbonate (DMC), diethyl carbonate (DEC), ethylmethyl carbonate (EMC); amides, such as formamide, acetamide, and N,N-dimethyl formamide; aliphatic carboxylic acid esters such as methyl formate, ethyl formate, methyl acetate, ethyl acetate, methyl propionate and ethyl propionate; diethers, such as 1,2-dimethoxyethane (DME), 1,2-diethoxyethane (DEE), and ethoxymethoxyethane (EME); cyclic ethers such as tetrahydrofuran, 2-methyl tetrahydrofuran, and dioxane; other aprotic organic solvents, such as acetonitrile, dimethyl sulfoxide, 1,3-propanesulton (PS) and nitromethane; and mixtures thereof. Typical lithium salts include, for example, lithium chloride (LiCl), lithium bromide (LiBr), lithium trifluoromethyl acetate (LiCF₃CO₂), lithium hexafluorophosphate (LiPF₆), lithium perchlorate (LiClO₄), lithium tetrafluoroborate (LiBF₄), lithium trifluoro-methansulfonate (LiCF₃SO₃), lithium hexafluoroarsenate (LiAsF₆), bis(trifluoromethyl)sulfonylimido lithium [LiN(CF₃SO₂)₂], lithium bisoxalato borate (LiB(C₂O₄)₂), and mixtures thereof.

Preferably, the non-aqueous electrolyte is one obtained by dissolving lithium hexafluorophosphate (LiPF₆) in a mixed solvent of ethylene carbonate (EC), which has a high dielectric constant, and a linear carbonate or mixture of linear carbonates that are low-viscosity solvents, such as, for example, diethyl carbonate (DEC), dimethyl carbonate (DMC), ethyl methyl carbonate (EMC). The concentration of lithium ion in the non-aqueous electrolyte is typically about 0.2 mol/l to about 2 mol/l, preferably about 0.5 mol/l to about 1.5 mol/l.

Other compounds may be added to the non-aqueous electrolyte in order to improve discharge and charge/discharge properties. Such compounds include triethyl phosphate, triethanolamine, cyclic ethers, ethylene diamine, pyridine, triamide hexaphosphate, nitrobenzene derivatives, crown ethers, quaternary ammonium salts, and ethylene glycol di-alkyl ethers.

Separator 5 is insoluble and stable in the electrolyte solution. It prevents short circuits by insulating the positive electrode from the negative electrode. Insulating thin films with fine pores, which have a large ion permeability and a predetermined mechanical strength, are used. Polyolefins, such as polypropylene and polyethylene, and fluorinated polymers such as polytetrafluoroethylene and polyhexafluoropropylene, can be used individually or in combination. Sheets, non-wovens and wovens made with glass fiber can also be used. The diameter of the fine pores of the separators is typically small enough so that positive electrode materials, negative electrode materials, binders, and conductive materials that separate from the electrodes can not pass through the separator. A desirable diameter is, for example, 0.01-1 μm. The thickness of the separator is generally 10-300 μm. The porosity is determined by the permeability of electrons and ions, material and membrane pressure, in general however, it is desirably 30-80%.

For polymer secondary batteries, gel electrolytes comprising these non-aqueous electrolytes retained in the polymer as plasticizers, may also be used. Alternatively, the electrolyte may be polymer solid electrolyte or gel polymer electrolyte, which comprises a polymer solid electrolyte mixed with organic solvent provided as a plasticizer. Effective organic solid electrolytes include polymer materials such as derivatives, mixtures and complexes of polyethylene oxide, polypropylene oxide, polyphosphazene, polyaziridine, polyethylene sulfide, polyvinyl alcohol, polyvinylidene fluoride, polyhexafluoropropylene. Among inorganic solid electrolytes, lithium nitrides, lithium halides, and lithium oxides are well known. Among them, Li₄SiO₄, Li₄SiO₄—LiI—LiOH, xLi₃PO₄-(1-x)Li₄SiO₄, Li₂SiS₃, Li₃PO₄—Li₂S—SiS₂ and phosphorus sulfide compounds are effective. A family of lithium excess garnet with the general formula Li₇La₃Zr₂O₁₂ described in R. Murugan, V. Thangadurai and W. Weppner, Angew. Chem. Int. Ed. Engl. 2007, 46, 7778-7781 herein incorporated by reference, may also be used as solid electrolytes. When a gel electrolyte is used, a separator is typically not necessary.

Negative electrode 1, positive electrode 3, separator 5, and the electrolyte are contained in battery case or can 12. The case may be made of example, titanium, aluminum, or stainless steel that is resistant to the electrolyte. As shown in FIG. 1, a non-aqueous secondary battery may also comprise lead tabs, safety vents, insulators, and other structures.

### INDUSTRIAL APPLICABILITY

This invention provides a negative electrode for a non-aqueous secondary battery and a non-aqueous secondary battery of high reliability and safety. These non-aqueous secondary batteries are used in portable electronic devices such as personal computers, cell phones and smart phones, as well as audio-visual electronic devices, such as video camcorders and MP3 players.

The advantageous properties of this invention can be observed by reference to the following examples, which illustrate but do not limit the invention.

### EXAMPLES

### General Procedures

Powder XRD diffraction was recorded using a Bruker D-8 advance theta-theta diffractometer with Cu Kα radiation. The scintillation detector was attached with graphite monochrometer. The operating voltage was set for the diffractometer at 40 kV with 30 mA filament current. The surface area and pore size distribution were measured using Micromeritics Gemini 6 surface area and pore size analyzer. Thermogravimetic analysis and differential calorimetric measurements were performed on TA instrument Q50 and Q10 series respectively. A Hitachi 3500 N Scanning Electron Microscope attached with Oxford INCA 350 EDX system was used to analyze the material for its morphology and composition.

### Example 1

This example illustrates the synthesis of an embodiment of the present invention containing nano-size silicon as the lithium-absorbing material.

0.15 g of nano-size silicon powder was applied and mixed with 9 grams of PLURONIC® P-123, a triblock copolymer composed of ethylene oxide and propylene oxide, in 100 mL glass jar. 3 g of ethanol and 0.8 g acetylene black was added to the jar and the contents were stirred. Then the solution was dried at 80° C. for 4 hrs. The dried material was calcinated at 600° C. under 1% hydrogen-99% argon gas atmosphere. The calcinated material was crushed and ground, and then shifted using a 200 mesh screen. The particle size of the resulting powder was under 75 μm.

The powder was mixed well with a polyvinylidene fluoride (PVdF)/N-methyl pyrrolidone (NMP) solution and coated on a stainless steel plate. The weight ratio of the powder and PVdF was 95:5 w/w. The coated electrode was then pressed 1 ton per cm² and dried at 120° C. for 4 hrs before the coin cell was assembled. The coin cell was assembled under argon gas atmosphere.

### Example 2

This example illustrates the synthesis of a comparable sample which includes a transition metal oxide and excludes carbon in the electrode material.

0.15 g of nano-size silicon powder was applied and mixed with 9 grams of PLURONIC® P-123, a triblock copolymer composed of ethylene oxide and propylene oxide, in 100 mL glass jar. 3 g of ethanol and 3 g of titanium iso-propoxide (Ti(OCH₂CH₃)₄) were added to the jar and the contents were mixed well. The pH of the solution was adjusted by adding 0.3 g of 1 M hydrochloric acid solution. Then the solution was dried at 80° C. for 4 hrs. The dried material was calcinated at 600° C. under 1% hydrogen-99% argon gas atmosphere. The calcinated material was crushed and ground, and then shifted using a 200 mesh screen. The particle size of the resulting powder was under 75 μm.

The powder was mixed well with a polyvinylidene fluoride (PVdF)/N-methyl pyrrolidone (NMP) solution and coated on a stainless steel plate. The weight ratio of the powder and PVdF was 95:5 w/w. The coated electrode was then pressed 1 ton per cm² and dried at 120° C. for 4 hrs before the coin cell was assembled. The coin cell was assembled under argon gas atmosphere.

### Example 3

This example illustrates the synthesis of a comparable sample which includes a transition metal oxide in the electrode material.

0.15 g of nano-size silicon powder was applied and mixed with 9 grams of PLURONIC® P-123, a triblock copolymer composed of ethylene oxide and propylene oxide, in 100 mL glass jar. 3 g of ethanol and 3 g of titanium iso-propoxide (Ti(OCH₂CH₃)₄) were added to the jar and the contents were mixed well. The pH of the solution was adjusted by adding 0.3 g of 1 M hydrochloric acid solution. Then the solution was dried at 80° C. for 4 hrs. The dried material was calcinated at 600° C. under 1% hydrogen-99% argon gas atmosphere. The calcinated material was crushed and ground, and then shifted using a 200 mesh screen. The particle size of the resulting powder was under 75 μm.

The powder was mixed well with acetylene black and a polyvinylidene fluoride (PVdF)/N-methylpyrrolidone (NMP) solution. Accordingly, the acetylene black in this example is external to the electrode active material particles and structure. The resulting material was then coated on a stainless steel plate. The weight ratio of the powder, acetylene black, and PVdF was 90:5:5 w/w. The coated electrode was then pressed 1 ton per cm² and dried at 120° C. for 4 hrs before the coin cell was assembled. The coin cell was assembled under argon gas atmosphere.

### Example 4

This example illustrates the synthesis of a comparable sample which includes the use of a 50% sucrose water solution to prepare the electrode material.

0.15 g of nano-size silicon powder was applied and mixed with 9 grams of PLURONIC® P-123, a triblock copolymer composed of ethylene oxide and propylene oxide, in 100 mL glass jar. 10.8 g of a 50% sucrose water solution was added to the jar and the contents were mixed well. Sucrose was used for this example but components such as, for example, lactose, fructose, glucose, and mixtures thereof may be used instead of, or in addition to, sucrose, as known by one having ordinary skill in the art. Then the solution was dried at 80° C. for 4 hrs. The dried material was calcinated at 600° C. under 1% hydrogen-99% argon gas atmosphere. The calcinated material was crushed and ground, and then shifted using a 200 mesh screen. The particle size of the resulting powder was under 75 μm.

The powder was mixed well with a polyvinylidene fluoride (PVdF)/N-methyl pyrrolidone (NMP) solution and coated on a stainless steel plate. The weight ratio of the powder and PVdF was 95:5 w/w. The coated electrode was then pressed 1 ton per cm² and dried at 120° C. for 4 hrs before the coin cell was assembled. The coin cell was assembled under argon gas atmosphere.

### Example 5

This example illustrates the synthesis of a comparable sample which includes the use of a 50% sucrose water solution, but not a surfactant, to prepare the electrode material.

0.15 g of nano-size silicon powder was applied and mixed with 10.8 g of a 50% sucrose water solution. Then the solution was dried at 80° C. for 4 hrs. The dried material was calcinated at 600° C. under 1% hydrogen-99% argon gas atmosphere. The calcinated material was crushed and ground, and then shifted using a 200 mesh screen. The particle size of the resulting powder was under 75 μm.

The powder was mixed well with a polyvinylidene fluoride (PVdF)/N-methyl pyrrolidone (NMP) solution and coated on a stainless steel plate. The weight ratio of the powder and PVdF was 95:5 w/w. The coated electrode was then pressed 1 ton per cm² and dried at 120° C. for 4 hrs before the coin cell was assembled. The coin cell was assembled under argon gas atmosphere.

### Coin Cell Battery Test Parameters

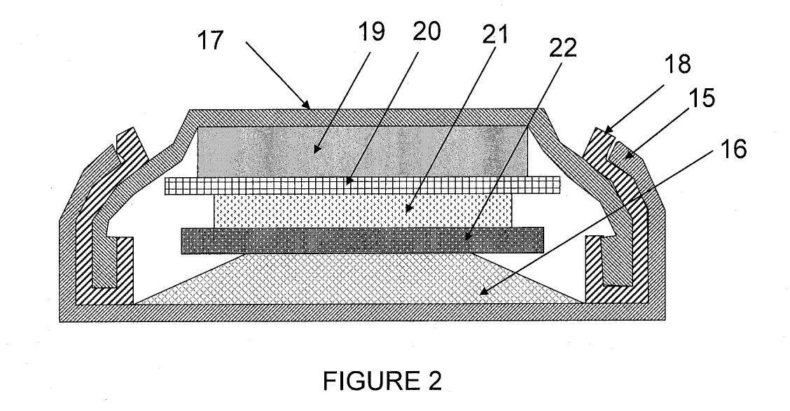

The negative electrode according to this invention, as described in Example 1, and the comparable samples described in Examples 2-5 were evaluated using a coin cell type battery as shown in FIG. 2. FIG. 2 shows a cross-section of the assembled coin cell battery. As is known to one having ordinary skill in the art, a coin cell includes a case 15 and a top can 17. A gasket 18 is disposed between the case 15 and the top can 17 to seal the internal components from external contaminations. A spring 16 is disposed within the case 15 and retained in place adjacent the case by a plate, such as a stainless steel plate 22. A lithium electrode 19, separator 20, and a negative electrode 21 are disposed between the top can 17 and the stainless steel plate 22, within the case 15. The separator 20 is positioned between the lithium electrode 19 and the negative electrode 21. The charging current rate was 1/10 CmA (constant current) to 0.8 V, while the discharging rate was 1/10 CmA (constant current) to 0 V. As is known to one having ordinary skill in the art, during charging and discharging, CmA is a value indicating current. It is expressed as a multiple of nominal capacity, and one can substitute “C” with the battery's nominal capacity when calculating the rate. The tests were conducted at 20° C.

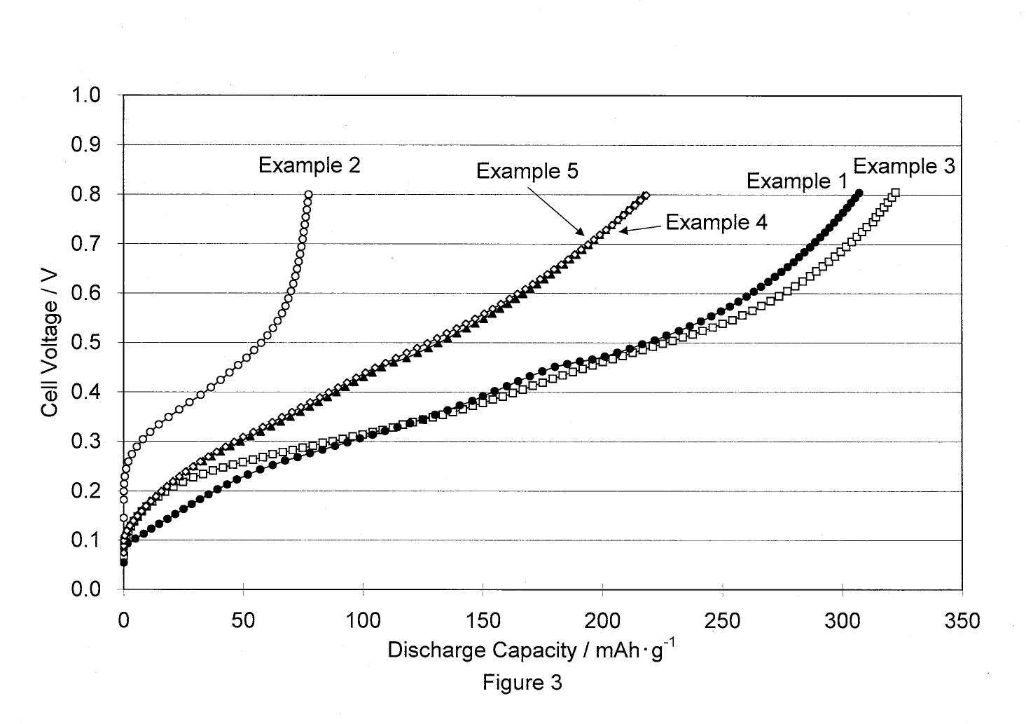

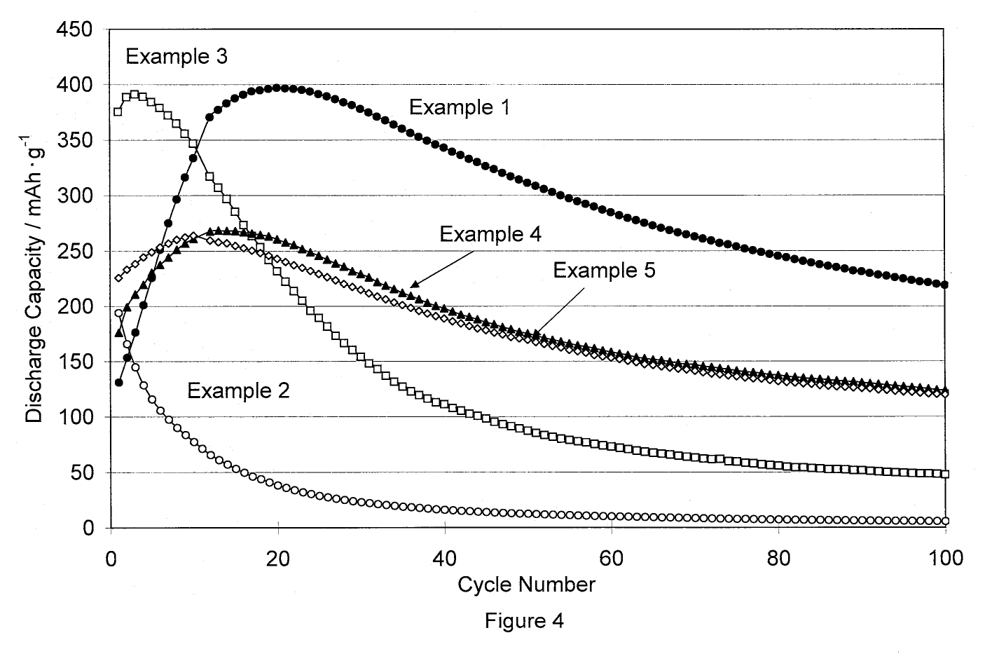

The results of the coin cell battery tests are shown in FIGS. 3 and 4. FIG. 3 shows the voltage vs. capacity charge/discharge curves for the materials described in Examples 1-5. FIG. 4 shows the charge-discharge cycle performance for the materials described in Examples 1-5.

In FIG. 3, discharge curves at 10 cycles are shown. As can be seen from FIG. 3, Example 1 showed smaller capacity than Example 3. However, Example 1 showed similar polarization with Example 3 which also includes acetylene black as an electronic conductive material in the electrode material. Example 2, which lacked the acetylene black, showed smaller capacity than Examples 1 and 3, which contained the acetylene black electronic conductive material. The concept that an electronic conductive material, such as a carbon like acetylene black, can contribute to the polarization performance is confirmed by Examples 4 and 5. Examples 4 and 5 include carbon from calcinated sucrose, present in the 50% sucrose solution. Examples 4 and 5 showed slightly lower polarization levels than Examples 1 and 3 even though those electrode materials did not include acetylene black. Without being held to the theory, it is believed that the carbon from the calcinated sucrose, present in the 50% sucrose solution, contributed as an electronic conductive material.

Charge-Discharge cyclic performances are shown in FIG. 3. As can be seen from FIG. 3, Example 1 possesses a higher capacity than the other Examples. Particularly, Example 3 which also includes acetylene black showed worse cycle performance than Examples 1, 4 and 5. This confirms the importance that an electronic conductive material, such as carbon, exists in the electrode active material as they are very effective for cycle performance. Comparing Examples 1 and 3 also confirm the importance that the electronic conductive material exists within the electrode active material rather than outside of the active material particles.

Though nano-size silicon particles were used as the main active material, nano-size silicon oxide (SiOx, 0<x<2), tin (Sn) and tin oxide (SnOx, 0<x_{—}2) particles, or any other material with large expansion when lithium is absorbed, or mixtures of any of these materials also could be used. Additionally, while the tests were performed using acetylene black, carbon black, vapor grown carbon fiber (VGCF), nano-carbon tubes, or any other carbon source material, or mixtures thereof can be used as the electronic conductive material.

Although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. An electrode of a non-aqueous electrolyte secondary battery, the electrode comprising:
a current collector; and
a mixture comprising an electrode active material and a binder on the current collector;
in which:
the electrode active material comprises a porous composite material of a conductive material and a lithium absorbing nano-material.

2. The electrode of claim 1, wherein the lithium absorbing nano-material is a nano-dimensional material, a nanoparticle, or a nanotube.

3. The electrode of claim 1, wherein the lithium absorbing nano-material is at least one of a group consisting of silicon, tin, silicon oxide, tin oxide, and mixtures thereof.

4. The electrode of claim 1, wherein the conductive material is particles of electronic conductive carbon.

5. The electrode of claim 1, wherein the conductive material is at least one of a group consisting of acetylene black, ketchen black, carbon black, vapor grown carbon fibers (VGCF), and mixtures thereof.

6. The electrode of claim 1, wherein the conductive material is derived from calcinated sucrose, lactose, fructose, glucose, or mixtures thereof.

7. An electrode of a non-aqueous electrolyte secondary battery, the electrode comprising:
a current collector; and
a mixture comprising an electrode active material and a binder on the current collector;
in which:
the electrode active material comprises a porous composite material, in which the porous composite material comprises a composite of carbon and nanoparticles of a lithium absorbing material.

8. The electrode of claim 7, wherein the nanoparticles of a lithium absorbing material are at least one of a group consisting of silicon, tin, silicon oxide, tin oxide, and mixtures thereof.

9. The electrode of claim 7, wherein the nanoparticles of a lithium absorbing material comprise silicon nanoparticles.

10. The electrode of claim 7, wherein the nanoparticles of a lithium absorbing material comprise tin nanoparticles.

11. The electrode of claim 7, wherein the porous composite material further comprises a surfactant.

12. The electrode of claim 7, wherein the porous composite material further comprises an organic solvent.

13. The electrode of claim 7, wherein the electrode active material additionally comprises absorbed lithium.

14. A non-aqueous electrolyte secondary battery comprising:
a positive electrode;
a negative electrode; and
a non-aqueous electrolyte between the positive electrode and the negative electrode;
in which:
the non-aqueous electrolyte comprises a non-aqueous solvent and lithium salt;
the positive electrode comprises a positive electrode current collector, and, on the positive electrode current collector, a mixture comprising a positive electrode active material and a first binder;
the negative electrode comprises a negative electrode current collector, and, on the negative electrode current collector, a mixture comprising a negative electrode active material and a second binder; and
either the negative electrode active material or the positive electrode active material comprises a porous composite material of conductive material and a lithium absorbing material.

15. The non-aqueous electrolyte secondary battery of claim 14, wherein the lithium absorbing material are at least one of a group consisting of silicon, tin, silicon oxide, tin oxide, and mixtures thereof.

16. The non-aqueous electrolyte secondary battery of claim 14, wherein the lithium absorbing material are nanoparticles of at least one of a group consisting of silicon, tin, silicon oxide, tin oxide, and mixtures thereof.

17. The non-aqueous electrolyte secondary battery of claim 14, wherein the lithium absorbing material comprise silicon nanoparticles.

18. The non-aqueous electrolyte secondary battery of claim 14, further comprising a separator.

19. The non-aqueous electrolyte secondary battery of claim 14, wherein electrode active material additionally comprises absorbed lithium.

20. An electrode of a non-aqueous electrolyte secondary battery, the electrode comprising:
a current collector; and
a mixture comprising an electrode active material and a binder on the current collector;
in which:
the electrode active material comprises a porous composite material of a conductive material and a lithium absorbing nano-material, wherein the conductive material is disposed within the electrode active material rather than outside of the active material.
